(19) United States
(12) Patent Application Publication
(10) Pub. No.: US 2022/0305373 A1
(43) Pub. Date: Sep. 29, 2022

(54) SOUND REDUCING DIRECTIONAL INPUT STICK

(71) Applicant: Microsoft Technology Licensing, LLC, Redmond, WA (US)

(72) Inventor: Carl Joseph LEDBETTER, Mercer Island, WA (US)

(21) Appl. No.: 17/212,760

(22) Filed: Mar. 25, 2021

(51) Int. Cl. A63F 13/24

(52) U.S. Cl. CPC A63F 13/24

(57) ABSTRACT

An electronic device controller includes a directional input stick that is movable within an aperture in a body of the electronic device controller. A damping ring is positioned between a shaft of the directional input stick and an edge of the aperture such that movement of the directional input stick toward the edge of the aperture compresses the damping ring between the shaft and the body. The damping ring is rotatable relative to the shaft and the body.

### BACKGROUND

### Background and Relevant Art

Electronic device controllers allow users to quickly provide directional inputs to a video game console or other computing device. Joysticks, thumbsticks, and other directional input sticks can allow for analog or digital directional inputs with an electronic device controller. The directional input sticks move the stick within a rotational range of motion relative to a controller body. At the end of the rotational range of motion, the directional input stick can contact the controller body, producing an unpleasant and/or undesirable sound and tactile vibration.

### BRIEF SUMMARY

In some implementations, a directional input stick includes a shaft, a head, and a damping ring. The head is connected to the shaft at a longitudinal end of the shaft. The damping ring is positioned circumferentially around the shaft and below the head. The damping ring includes a bearing material and a damping material. The bearing material is positioned circumferentially around and contacts an outer surface of the shaft. The damping material is positioned circumferentially around the bearing material and fixed relative to the bearing material. The damping material has a lesser durometer than the bearing material.

In some implementations, an electronic device controller includes a body, a directional input stick, and a damping ring. The body has a top face with an aperture therein. The directional input stick is positioned in the aperture and movable relative to the body to receive user inputs. The directional input stick includes a shaft and a head. The head is connected to the shaft at a longitudinal end of the shaft. The damping ring is positioned circumferentially between an edge of the aperture and the directional input stick. The damping ring includes a bearing material and a damping material. The damping material is fixed relative to the bearing material. The damping material has a lesser durometer than the bearing material.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1-1 is a top view of an electronic device controller;

FIG. 1-2 is a side perspective view of the electronic device controller of FIG. 1-1;

FIG. 2 is a side cross-sectional detail view of an electronic device controller;

FIG. 3 is a side view of a directional input stick, according to at least some implementations of the present disclosure;

FIG. 4 is a side cross-sectional detail view of a directional input stick, according to at least some implementations of the present disclosure;

FIG. 5 is a side partial cross-sectional detail view of a directional input stick, according to at least some implementations of the present disclosure;

FIG. 6 is a side cross-sectional detail view of an electronic device controller with a first damping ring, according to at least some implementations of the present disclosure;

FIG. 7 is a side cross-sectional detail view of the electronic device controller of FIG. 6 with a second damping ring, according to at least some implementations of the present disclosure;

FIG. 8 is an axial cross-sectional view of a damping ring, according to at least some implementations of the present disclosure;

FIG. 9 is an axial cross-sectional view of a damping ring with race bearings, according to at least some implementations of the present disclosure;

FIG. 10 is a side cross-sectional detail view of an electronic device controller with a damping ring connected to a controller body, according to at least some implementations of the present disclosure; and

FIG. 11 is a schematic diagram of an electronic device controller system, according to at least some implementations of the present disclosure.

### DETAILED DESCRIPTION

The present disclosure relates generally to systems and methods for providing user inputs to an electronic device. More particularly, the input devices described herein are configured to allow directional inputs to a computing device or a specialized video game console. In some implementations, an input device according to the present disclosure is an electronic device controller that may be in data communication with an electronic device, such as a personal computer or video game console. In some implementations, a controller is in data communication via a wired data connection. In other implementations, the controlled is in wireless data communication.

Controllers include directional input devices to allow a user to indicate a direction an on-screen cursor or avatar should move relative to an environment. In some instances, an analog or digital thumbstick is appropriate to provide directional inputs to move an avatar in a relation to a three-dimensional virtual environment. For example, the analog thumbstick allows a gradient of input magnitudes with an associated directional component that allows for control of an avatar from a slow walk through a full run in the virtual environment.

During operation of the directional input stick, a user may rapidly move the directional input stick and forcefully contact a body of the controller. Upon contact with the controller body, the shaft or head of the directional input stick may produce an unpleasant or desirable sound or tactile vibration through the controller to the user. In some implementations, a controller according to the present disclosure includes a damping structure positioned between the directional input stick and the controller body, such that when the directional input stick is moved relative to the controller body, the damping structure absorbs a portion of the impact to reduce the sound and/or tactile vibrations produced by the contact. In some implementations, the damping structure is a ring positioned on and movable with the directional stick relative to the controller body. In some implementations, the damping structure is positioned on the controller body, such that the directional input stick is movable relative to the damping structure.

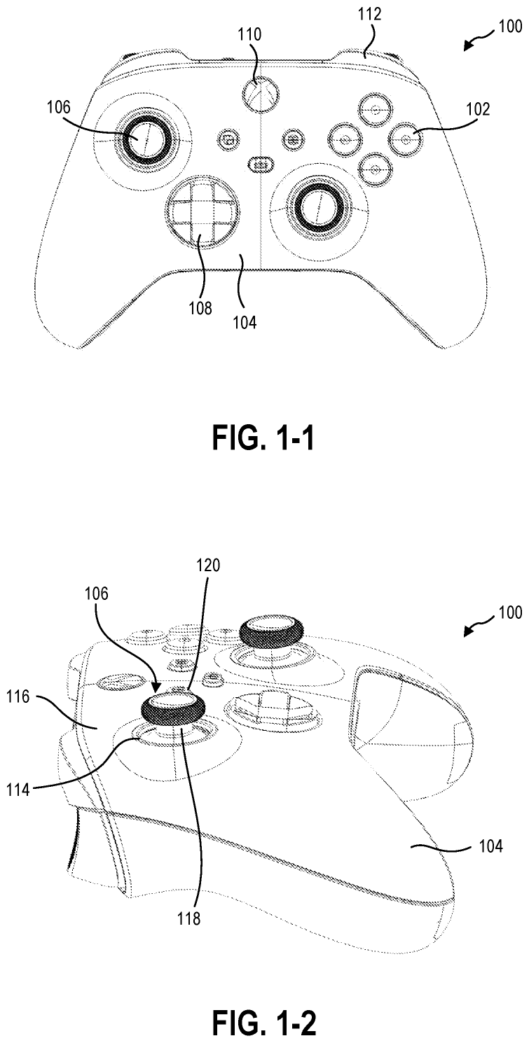

Referring now to FIG. 1, in some implementations, an electronic device controller 100 includes a plurality of other input buttons 102 located on a body 104 of the controller 100 with the directional input devices. The directional input devices may include one or more analog thumbsticks 106 and/or one or more directional control pads 108. The controller 100 may further include one or more menu or system buttons 110, shoulder buttons 112, trigger buttons, rear paddles, etc.

The thumbstick 106 may be used to control the movement of an avatar or cursor in a two- or three-dimensional virtual environment. As such, rapid inputs can require rapid movement of the thumbstick 106, which may produce noise or tactile vibration upon contact between the thumbstick 106 and the body 104.

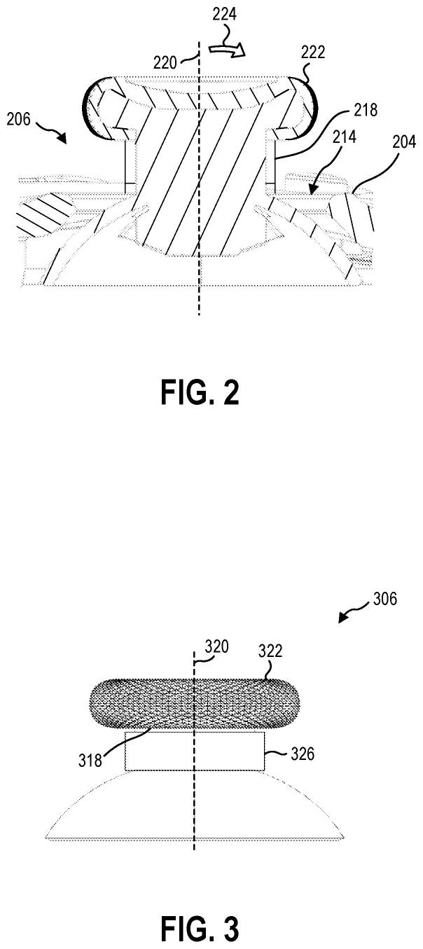

FIG. 1-2 is a side perspective view of the electronic device controller 100 of FIG. 1-1. The thumbstick 106 is located in an aperture 114 through the top face 116 of the controller body 104. The thumbstick 106 is movable relative to the body 104 by tilting the thumbstick 106 to translate and rotate a shaft 118 of the thumbstick 106 toward an edge of the aperture 114. The shaft 118 may contact the edge of the aperture, producing a sound and vibration through electronic device controller 100. In some implementations, the aperture 114 is circular, such that a range of motion of the thumbstick 106 is rotationally symmetrical about a center axis 120 of the thumbstick 106. In other implementations, the aperture 114 is non-circular or asymmetrical to allow different amounts of motion in different directions relative to the center axis 120.

FIG. 2 is a side cross-sectional view of an implementation of a conventional directional input stick 206. The directional input stick 206 has a center axis 220 that follows the center of the shaft 214 and a head 222 projecting above the body 204. The user may apply forces 224 to the head 222 to move the directional input stick 206. The directional input stick 206 has a rotational range of motion defined by the angular motion 224 of the center axis 220 as the directional input stick 206 moves toward the edge of the aperture 214 in the body 204 in response to the force 224 applied by the user. In some implementations, the range of motion is limited by a contact of the outer surface of the shaft 218 and body 204 at the edge of the aperture 214. Because the range of motion of the directional input stick 206 is limited by the contact between the shaft 218 and the body 204, a user will move the directional input stick 206 through the rotational range of motion and impact the body many times during operation.

FIG. 3 is a side view of an implementation of a directional input stick 306, according to the present disclosure. The directional input stick 306 includes a shaft 318 and a head 322. In some implementations, the head 322 includes a textured or ribbed surface to improve the user's grip on the head 322 during use and limit slipping of the user's thumb or hand on the head 322. In some implementations, a damping ring 326 is positioned around the shaft 318 such that impacts of the directional input stick 306 against a body of an electronic device controller are damped to reduce sound and tactile vibrations.

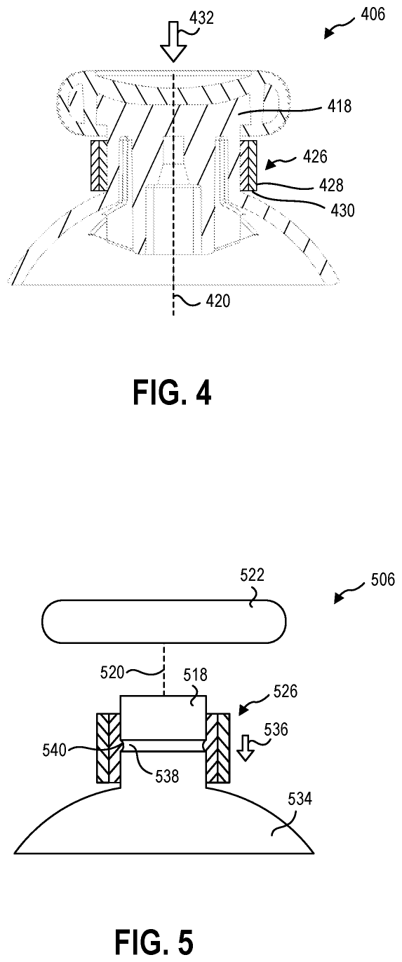

In some implementations, the damping ring includes two or more materials layered radially relative to the center axis 320 of the directional input stick 306. FIG. 4 is a cross-sectional view of an implementation of a directional input stick 406 similar to that described in relation to FIG. 3. The directional input stick 406 includes a damping ring 426 positioned around the shaft 418. In some implementations, the damping ring 426 includes a damping material 428 on a radially outward side of the damping ring 426 relative to the shaft 418. The damping material 428 may include synthetic rubber, natural rubber, other elastomers, soft polymers, or other materials that cushion and/or dissipate the impact of the directional input stick 406 contacting the body of the controller.

The softer material of the damping material 428 may wear more rapidly than a harder material due to friction between the directional input stick 406 and the body of the controller during use, however. For example, the user may tilt the directional input stick 406 through the rotational range of motion (e.g., tilt the center axis 420 of the directional input stick 406) and compress the damping ring 426 between the shaft 418 and the body of the controller. If the user then sweeps the directional input stick 406 in an arc around a portion of the aperture edge, the relatively soft damping material 428 may resist sliding due to friction therebetween.

The damping ring 426, in some implementations, includes a bearing material 430 positioned between the damping material 428 and the shaft 418. The bearing material 430 has a greater durometer (e.g., is harder) than the damping material 428. In some implementations, the bearing material 430 has a lower coefficient of friction against the shaft material and/or body material than the damping material 428. In some implementations, the bearing material 430 is a lubricious layer. The bearing material 430 allows the damping ring 426 to rotate around the shaft 418 during use of the directional input stick 406. The rotation of the damping ring 426 may reduce or prevent the frictional wear of the damping material 428. The bearing material 430 may include polymers such as polyoxymethylene, polytetrafluoroethylene, polycarbonate, or acrylonitrile butadiene styrene; ceramic materials; metal alloys; and other low-friction materials.

In some implementations, the damping ring 426 may be slidable in an axial direction (i.e., in the direction of the center axis 420) along the shaft 418. For example, some directional input sticks 406 are “clickable” in an electronic device controller wherein the directional input stick 406 may be depressed by application of a downward force 432 in a direction normal to the top face of the controller body. When the directional input stick 406 is depressed by a downward force 432 while the damping ring 426 is in contact with the body of the controller, the damping ring 426 may slide axially to limit and/or prevent wear on the damping material 428.

The damping ring 426 may, with prolonged use, wear and begin to crack, deteriorate, or otherwise fail to provide a quiet experience for the user. In some implementations, the damping ring 426 is replaceable by moving the damping ring 426 axially off the shaft 418. For example, FIG. 5 is a side partial view of another implementation of a directional input stick 506 with a damping ring 526. The head 522 of the directional input stick 506 is removable from the shaft 518 to allow the damping ring 526 to be removed. In other implementations, the shaft 518 is removable from a base 534 of the directional input stick 506 to allow the damping ring 526 to be removed. The damping ring 526 may be moved in an axial direction 536 along the center axis 520 of the shaft 518 to remove and/or replace the damping ring 526 on the shaft 518.

In some implementations, a détente or other mechanical interlock between the shaft 518 and the damping ring 526 holds the damping ring 526 in place on the directional input stick 506. For example, the shaft 518 may include a circumferential recess 538 in the outer surface of the shaft 518. One or more complementary protrusions 540 on an inner surface of the bearing material 528 may be positioned in the circumferential recess 538. In some implementations, circumferential recess 538 allows the protrusion 540, and hence the bearing material 528, to rotate freely around the shaft 518 while limiting and/or preventing the axial movement of the bearing material 528 relative to the shaft 518.

The damping ring 526 may be elastically deformable to allow the inner surface of the bearing material 528 including the protrusion 540 to be urged axially and allow the protrusion 540 to exit the circumferential recess. The relatively low coefficient of friction of the bearing material 528 may then allow the damping ring 526 to slide axially off the shaft 518.

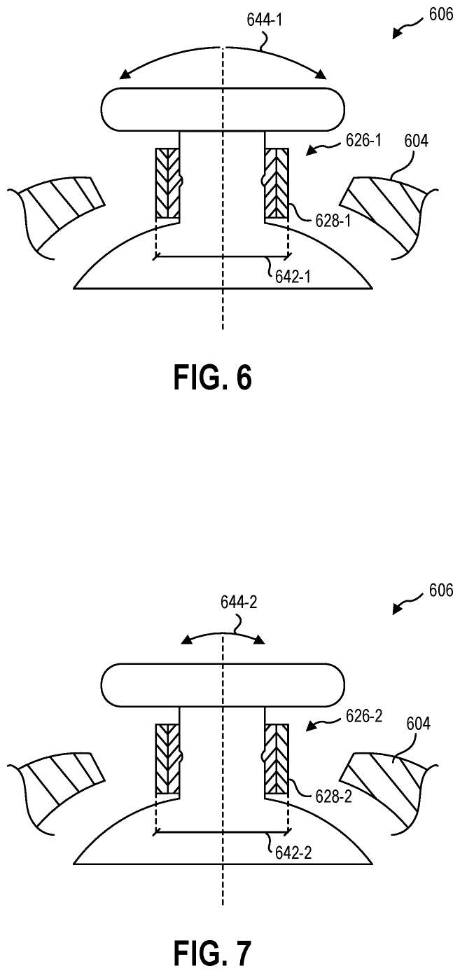

In some implementations, the selective replacement of the damping ring allows a user to adjust the range of motion of the directional input stick. FIG. 6 and FIG. 7 are side detail views of an implementation of a directional input stick 606 with a first damping ring 626-1 and a second damping ring 626-2, respectively. As described in relation to FIG. 4, the damping ring 626-1, 626-2 may be replaceable and/or interchangeable. In some implementations, changing a first damping ring 626-1 to a second damping ring 626-2 may allow customization of the sound, feel, and/or operation of the directional input stick 606. For example, a first damping material 626-1 and second damping material 626-2 may have different durometers to adjust the tactile feeling of the directional input stick 606 contacting the body 604 of the electronic device controller. In another example, the first damping ring 626-1 and second damping ring 626-2 may have different outer diameters 642-1, 642-2. Because the radially outer surface of damping ring 626-1, 626-2 contacts the body 604 of the electronic device controller, the outer diameter 642-1, 642-2 may affect the range of motion 644-1, 644-2 of the directional input stick 606.

The first damping ring 626-1 has a first outer diameter 642-1 that is less than the second outer diameter 642-2 of the second damping ring 626-2. While FIG. 6 and FIG. 7 illustrate implementations of damping rings 626-1, 626-2 with damping materials 628-1, 628-2 of different annular thickness, the outer diameter 642-2, 642-2 of the damping rings 626-1, 626-2 may be changed in any number of ways including but not limited to changing the radial thickness of the damping material or the bearing material, adding additional materials or coatings, or replacing the shaft with a second shaft of different radius. By exchanging the first damping ring 626-1 for the second damping ring 626-2, a user may change the position at which the directional input stick 606 contacts the body 604 of the electronic device controller, which, in turn, reduces the first rotational range of motion 644-1 of the directional input stick 606 to the smaller second rotational range of motion 644-2 of the directional input stick 606.

Such customization may be desirable to limit the input range of the directional input stick 606 for precision control of the electronic device of software application executed thereon. For example, the second damping ring 626-2 may provide a second rotational range of motion 644-2 that is approximately 80% of the first rotational rate of motion 644-1. Without further changes to the software or firmware communicating with the directional input stick 606, the maximum available directional input magnitude of the directional input stick 606 with the second damping ring 626-2 is approximately 80% of the maximum directional input magnitude of the directional input stick 606 with the first damping ring 626-1.

In other implementations, the user may adjust the firmware or software communicating with the directional input stick 606 to at least partially compensate for the second rotational range of motion 644-2. In such an implementation, the user may set the firmware or software to interpret the relative 50% tilt of the second rotational range of motion 644-2 as a 100% magnitude directional input. For example, a user can reduce the rotational range of motion of the directional input stick 606 while retaining the ability to provide the same magnitude directional inputs. In some examples, a shorter rotational range of motion may be beneficial or desirable to users with smaller hands. In some examples, a shorter rotational range of motion may be beneficial or desirable to a user desiring faster directional inputs, such as during competitive computer game play. Replaceable damping rings 626-1, 626-2 can, therefore, allow a user to tune the feel and range of motion of the directional input stick 606 to the specific user and application.

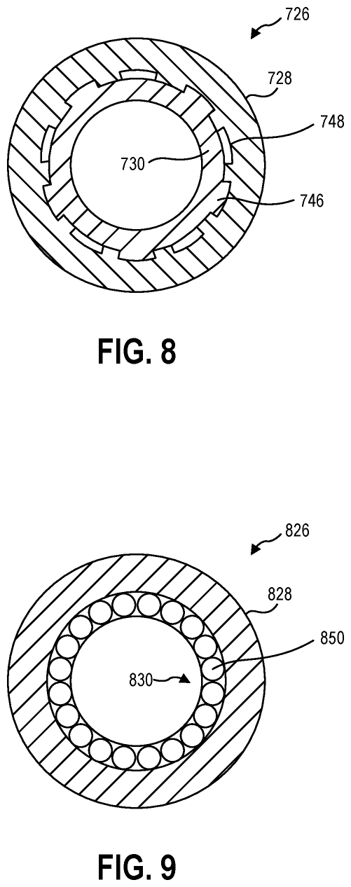

FIG. 8 is an axial cross-section of an implementation of a damping ring 726. In some implementations, the damping material 728 is overmolded on the bearing material 730. In some implementations, the bearing material 730 includes one or more surface features 746, such as protrusions that project radially outward or recesses radially inward from an outer surface of the bearing material 730, to mechanically interlock with the damping material 728. The bearing material 730 and damping material 728 may be rotationally fixed relative to one another by the mechanical interlock of the surface features 746 and the overmolded damping material 728.

In some implementations, the damping ring 726 provides additional shock absorption and/or cushioning beyond the bulk compliance of the damping material 728. For example, the damping ring 726 may include one or more voids 748 positioned between the damping material 728 and the bearing material 730 to allow the damping material 728 to elastically deform into the voids 748. The elastic deformation of the damping material 728 into the voids 748 can allow additional compliance of the damping ring 726 under higher levels of force applied by the user, further limiting the potential damage to the damping ring 726 and increasing the operational lifetime of the damping ring 726.

In some implementations, the bearing material includes race bearings upon which the damping material may move, such as illustrated schematically in the axial cross-section in FIG. 9. In some implementations, the bearing material 830 of the damping ring 826 includes spherical bearings 850, upon which the damping material 828 may move. In some implementations, the bearing material 830 of the damping ring 826 includes cylindrical bearings 850.

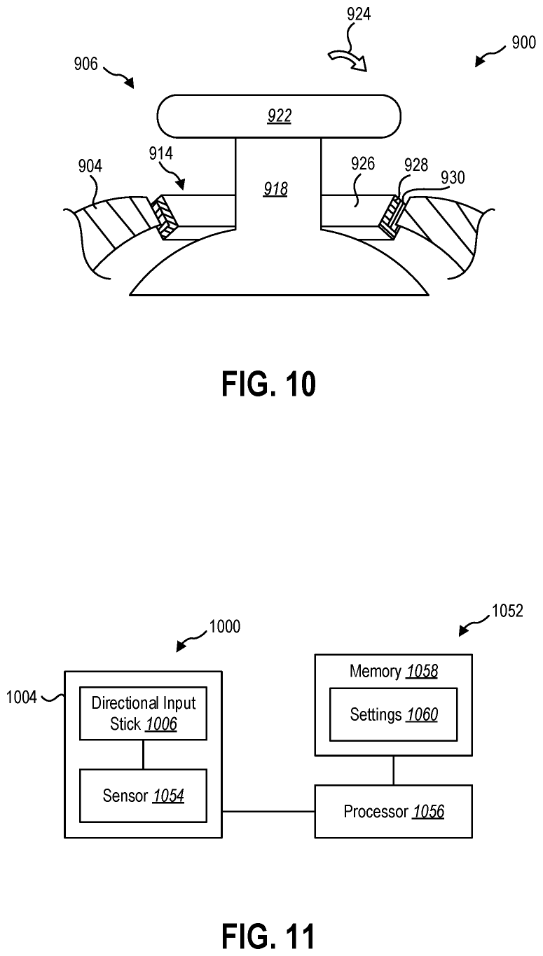

In some implementations, the damping ring is connected to the edge of the aperture, allowing the directional input stick to move independently of the damping ring, while the damping ring is still positioned between the body of the controller and the directional input stick. FIG. 10 is a partial cross-sectional side view of an electronic device controller 900 with a conventional directional input stick 906. The electronic device controller 900 includes a damping ring 926 positioned on the body 904 of the electronic device controller 900.

In some implementations, the damping ring 926 is connected to the edge of an aperture 914 in the body 904 through a snap fit. The bearing material 930 contacts the body 904 to allow the damping ring 926 to rotate around a perimeter of the aperture 914. The damping material 928 is adhered to or overmolded on the bearing material 930. When the user applies a force 924 to the head 922 of the directional input stick 906, the shaft 918 may contact the damping material 928. If the user sweeps the directional input stick 906 in an arc along the perimeter of the aperture 914, the friction between the shaft 918 and the damping material 928 may rotate the damping ring 926.

A damping ring 926 positioned on the body 904 of the electronic device controller 900 may, in some implementations, include one or more features of any damping ring implementations described in relation to FIG. 3 through FIG. 9. For example, a damping ring 926 positioned on the body 904 may include the voids 748 described in relation to FIG. 8. In some implementations, the damping ring 926 positioned on the body 904 may be replaceable with damping rings of various thicknesses to vary the range of motion of the directional input stick 906, as described in relation to FIG. 6 and FIG. 7. The user may adjust one or more settings in the firmware or software in communication with the electronic device controller 900 to adjust the magnitude of the direction inputs based on the damping ring 926 size.

FIG. 11 is a schematic diagram of an implementation of an electronic device controller system 1052 with adjustable directional input magnitudes. In some implementations, a potentiometer or other positional sensor 1054 measures a position of a directional input stick 1006 relative to a body 1004 of the electronic device controller 1000. The sensor 1054 is in data communication with a processor 1056. In some implementations, the processor 1056 is incorporated into and/or part of the electronic device controller 1000. In some implementations, the processor 1056 is in data communication with, but independent of, the electronic device controller 1000. The processor 1056 is configured to access a memory storage device 1058 having input stick settings 1060 stored thereon. In some implementations, the input stick settings include information regarding how the processor 1056 interprets measurements from the sensor 1054. For example, the input stick settings 1060 may include a neutral deadzone for the center position of the directional input stick 1006 to ignore small deviations from the neutral position. A neutral deadzone can prevent unintended inputs and limit the effects of drift in the sensor 1054.

In some implementations, the settings 1060 include input coefficients and/or limit values. For example, an input coefficient can instruct the processor 1056 to multiply the received measurement from the sensor 1060 by the input coefficient to determine the magnitude of the directional input from the directional input stick 1006. In an example, a movement of the directional input stick 1006 to contact the body of the electronic device controller may produce a measurement of 1.0 at the sensor 1054 and a movement of the directional input stick 1006 of 50% of the way to the edge of the aperture in the body may produce measurement of 0.5. With an input coefficient of 2.0, the 50% position of the directional input stick 1006 is measured, by the sensor 1540, to be 0.5 but determined, by the processor 1056, to be a 1.0 magnitude directional input.

A limit value of the settings 1060 may instruct the processor 1056 to limit at calculated magnitude to a particular value, irrespective of the measured value at the sensor 1054. In the previous example, a measurement of the directional input stick 1006 at 0.8 by the sensor 1054 would be determined, by the processor 1056, to have a magnitude of 1.6. In some implementations, a limit value can limit the magnitude of the determined input to 1.0. The result would be a system 1052 that interprets inputs up to 50% of the range of motion of the directional input stick 1006 to be twice the measured input but limits the input to a maximum directional input magnitude of 1.0. A damping ring that limits the range of motion of the directional input stick 1006 by 50% would, therefore, reduce the amount of movement needed to input a 1.0 magnitude input, while having no other limiting effect on the inputs.

Implementations of a damping ring according to the present disclosure may reduce noise and/or tactile vibrations during use of a directional input stick, and, in some implementations, provide additional degrees of customization to tune the feel and performance of the directional input stick to a user or application.

### INDUSTRIAL APPLICABILITY

The present disclosure relates generally to systems and methods for providing user inputs to an electronic device. More particularly, the input devices described herein are configured to allow directional inputs to a computing device or a specialized video game console. In some implementations, an input device according to the present disclosure is an electronic device controller that may be in data communication with an electronic device, such as a personal computer or video game console. In some implementations, a controller is in data communication via a wired data connection. In other implementations, the controlled is in wireless data communication.

Controllers include directional input devices to allow a user to indicate a direction an on-screen cursor or avatar should move relative to an environment. In some instances, an analog or digital thumbstick is appropriate to provide directional inputs to move an avatar in a relation to a three-dimensional virtual environment. For example, the analog thumbstick allows a gradient of input magnitudes with an associated directional component that allows for control of an avatar from a slow walk through a full run in the virtual environment.

During operation of the directional input stick, a user may rapidly move the directional input stick and forcefully contact a body of the controller. Upon contact with the controller body, the shaft or head of the directional input stick may produce an unpleasant or desirable sound or tactile vibration through the controller to the user. In some implementations, a controller according to the present disclosure includes a damping structure positioned between the directional input stick and the controller body, such that when the directional input stick is moved relative to the controller body, the damping structure absorbs a portion of the impact to reduce the sound and/or tactile vibrations produced by the contact. In some implementations, the damping structure is a ring positioned on and movable with the directional stick relative to the controller body. In some implementations, the damping structure is positioned on the controller body, such that the directional input stick is movable relative to the damping structure.

In some implementations, a directional input stick has a center axis that follows the center of a shaft and a head projecting above a body of the controller. The user may apply forces to the head to move the directional input stick. The directional input stick has a rotational range of motion defined by the angular motion of the center axis as the directional input stick moves toward the edge of an aperture in the body in response to the force applied by the user. In some implementations, the range of motion is limited by a contact of the outer surface of the shaft and body at the edge of the aperture. Because the range of motion of the directional input stick is limited by the contact between the shaft and the body, a user will move the directional input stick through the rotational range of motion and impact the body many times during operation.

In some implementations, the head includes a textured or ribbed surface to improve the user's grip on the head during use and limit slipping of the user's thumb or hand on the head. In some implementations, a damping ring is positioned around the shaft such that impacts of the directional input stick against a body of an electronic device controller are damped to reduce sound and tactile vibrations.

In some implementations, the damping ring includes two or more materials layered radially relative to the center axis of the directional input stick. In some implementations, the damping ring includes a damping material on a radially outward side of the damping ring relative to the shaft. The damping material may include synthetic rubber, natural rubber, other elastomers, soft polymers, or other materials that cushion and/or dissipate the impact of the directional input stick contacting the body of the controller.

The softer material of the damping material may wear more rapidly than a harder material due to friction between the directional input stick and the body of the controller during use, however. For example, the user may tilt the directional input stick through the rotational range of motion (e.g., tilt the center axis of the directional input stick) and compress the damping ring between the shaft and the body of the controller. If the user then sweeps the directional input stick in an arc around a portion of the aperture edge, the relatively soft damping material may resist sliding due to friction therebetween.

The damping ring, in some implementations, includes a bearing material positioned between the damping material and the shaft. The bearing material has a greater durometer (e.g., is harder) than the damping material. In some implementations, the bearing material has a lower coefficient of friction against the shaft material and/or body material than the damping material. In some implementations, the bearing material is a lubricious layer. The bearing material allows the damping ring to rotate around the shaft during use of the directional input stick. The rotation of the damping ring may reduce or prevent the frictional wear of the damping material. The bearing material may include polymers such as polyoxymethylene, polytetrafluoroethylene, polycarbonate, or acrylonitrile butadiene styrene; ceramic materials; metal alloys; and other low-friction materials.

In some implementations, the damping ring may be slidable in an axial direction (i.e., in the direction of the center axis) along the shaft. For example, some directional input sticks are “clickable” in an electronic device controller wherein the directional input stick may be depressed by application of a downward force in a direction normal to the top face of the controller body. When the directional input stick is depressed by a downward force while the damping ring is in contact with the body of the controller, the damping ring may slide axially to limit and/or prevent wear on the damping material.

The damping ring may, with prolonged use, wear and begin to crack, deteriorate, or otherwise fail to provide a quiet experience for the user. In some implementations, the damping ring is replaceable by moving the damping ring axially off the shaft. In some implementations, the head of the directional input stick is removable from the shaft to allow the damping ring to be removed. In other implementations, the shaft is removable from a base of the directional input stick to allow the damping ring to be removed. The damping ring may be moved in an axial direction along the center axis of the shaft to remove and/or replace the damping ring on the shaft.

In some implementations, a détente or other mechanical interlock between the shaft and the damping ring holds the damping ring in place on the directional input stick. For example, the shaft may include a circumferential recess in the outer surface of the shaft. One or more complementary protrusions on an inner surface of the bearing material may be positioned in the circumferential recess. In some implementations, circumferential recess allows the protrusion, and hence the bearing material, to rotate freely around the shaft while limiting and/or preventing the axial movement of the bearing material relative to the shaft.

The damping ring may be elastically deformable to allow the inner surface of the bearing material including the protrusion to be urged axially and allow the protrusion to exit the circumferential recess. The relatively low coefficient of friction of the bearing material may then allow the damping ring to slide axially off the shaft.

In some implementations, the selective replacement of the damping ring allows a user to adjust the range of motion of the directional input stick. As described herein, the damping ring may be replaceable and/or interchangeable. In some implementations, changing a first damping ring to a second damping ring may allow customization of the sound, feel, and/or operation of the directional input stick. For example, a first damping material and second damping material may have different durometers to adjust the tactile feeling of the directional input stick contacting the body of the electronic device controller. In another example, the first damping ring and second damping ring may have different outer diameters. Because the radially outer surface of damping ring contacts the body of the electronic device controller, the outer diameter may affect the range of motion of the directional input stick.

The first damping ring has a first outer diameter that is less than the second outer diameter of the second damping ring. The outer diameter of the damping rings may be changed in any number of ways including but not limited to changing the radial thickness of the damping material or the bearing material, adding additional materials or coatings, or replacing the shaft with a second shaft of different radius. By exchanging the first damping ring for the second damping ring, a user may change the position at which the directional input stick contacts the body of the electronic device controller, which, in turn, reduces the first rotational range of motion of the directional input stick to the smaller second rotational range of motion of the directional input stick.

Such customization may be desirable to limit the input range of the directional input stick for precision control of the electronic device of software application executed thereon. For example, the second damping ring may provide a second rotational range of motion that is approximately 80% of the first rotational rate of motion. Without further changes to the software or firmware communicating with the directional input stick, the maximum available directional input magnitude of the directional input stick with the second damping ring is approximately 80% of the maximum directional input magnitude of the directional input stick with the first damping ring.

In other implementations, the user may adjust the firmware or software communicating with the directional input stick to at least partially compensate for the second rotational range of motion. In such an implementation, the user may set the firmware or software to interpret the relative 50% tilt of the second rotational range of motion as a 100% magnitude directional input. For example, a user can reduce the rotational range of motion of the directional input stick while retaining the ability to provide the same magnitude directional inputs. In some examples, a shorter rotational range of motion may be beneficial or desirable to users with smaller hands. In some examples, a shorter rotational range of motion may be beneficial or desirable to a user desiring faster directional inputs, such as during competitive computer game play. Replaceable damping rings can, therefore, allow a user to tune the feel and range of motion of the directional input stick to the specific user and application.

In some implementations, the damping material is overmolded on the bearing material. In some implementations, the bearing material includes one or more surface features, such as protrusions that project radially outward or recesses radially inward from an outer surface of the bearing material, to mechanically interlock with the damping material. The bearing material and damping material may be rotationally fixed relative to one another by the mechanical interlock of the surface features and the overmolded damping material.

In some implementations, the damping ring provides additional shock absorption and/or cushioning beyond the bulk compliance of the damping material. For example, the damping ring may include one or more voids positioned between the damping material and the bearing material to allow the damping material to elastically deform into the voids. The elastic deformation of the damping material into the voids can allow additional compliance of the damping ring under higher levels of force applied by the user, further limiting the potential damage to the damping ring and increasing the operational lifetime of the damping ring.

In some implementations, the bearing material includes race bearings upon which the damping material may move. In some implementations, the bearing material of the damping ring includes spherical bearings, upon which the damping material may move. In some implementations, the bearing material of the damping ring includes cylindrical bearings.

In some implementations, the damping ring is connected to the edge of the aperture, allowing the directional input stick to move independently of the damping ring, while the damping ring is still positioned between the body of the controller and the directional input stick.

In some implementations, the damping ring is connected to the edge of an aperture in the body through a snap fit. The bearing material contacts the body to allow the damping ring to rotate around a perimeter of the aperture. The damping material is adhered to or overmolded on the bearing material. When the user applies a force to the head of the directional input stick, the shaft may contact the damping material. If the user sweeps the directional input stick in an arc along the perimeter of the aperture, the friction between the shaft and the damping material may rotate the damping ring.

A damping ring positioned on the body of the electronic device controller may, in some implementations, include one or more features of any damping ring implementations described herein. For example, a damping ring positioned on the body may include voids described herein. In some implementations, the damping ring positioned on the body may be replaceable with damping rings of various thicknesses to vary the range of motion of the directional input stick, as described herein. The user may adjust one or more settings in the firmware or software in communication with the electronic device controller to adjust the magnitude of the direction inputs based on the damping ring size.

In some implementations, an electronic device controller system has adjustable directional input magnitudes. In some implementations, a potentiometer or other positional sensor measures a position of a directional input stick relative to a body of the electronic device controller. The sensor is in data communication with a processor. In some implementations, the processor is incorporated into and/or part of the electronic device controller. In some implementations, the processor is in data communication with, but independent of, the electronic device controller. The processor is configured to access a memory storage device having input stick settings stored thereon. In some implementations, the input stick settings include information regarding how the processor interprets measurements from the sensor. For example, the input stick settings may include a neutral deadzone for the center position of the directional input stick to ignore small deviations from the neutral position. A neutral deadzone can prevent unintended inputs and limit the effects of drift in the sensor.

In some implementations, the settings include input coefficients and/or limit values. For example, an input coefficient can instruct the processor to multiply the received measurement from the sensor by the input coefficient to determine the magnitude of the directional input from the directional input stick. In an example, a movement of the directional input stick to contact the body of the electronic device controller may produce a measurement of 1.0 at the sensor and a movement of the directional input stick of 50% of the way to the edge of the aperture in the body may produce measurement of 0.5. With an input coefficient of 2.0, the 50% position of the directional input stick is measured, by the sensor, to be 0.5 but determined, by the processor, to be a 1.0 magnitude directional input.

A limit value of the settings may instruct the processor to limit at calculated magnitude to a particular value, irrespective of the measured value at the sensor. In the previous example, a measurement of the directional input stick at 0.8 by the sensor would be determined, by the processor, to have a magnitude of 1.6. In some implementations, a limit value can limit the magnitude of the determined input to 1.0. The result would be a system that interprets inputs up to 50% of the range of motion of the directional input stick to be twice the measured input but limits the input to a maximum directional input magnitude of 1.0. A damping ring that limits the range of motion of the directional input stick by 50% would, therefore, reduce the amount of movement needed to input a 1.0 magnitude input, while having no other limiting effect on the inputs.

Implementations of a damping ring according to the present disclosure may reduce noise and/or tactile vibrations during use of a directional input stick, and, in some implementations, provide additional degrees of customization to tune the feel and performance of the directional input stick to a user or application.

The present disclosure relates to systems and methods for providing directional inputs according to at least the examples provided in the sections below:
1. A directional input stick, the input stick comprising:
   a shaft;
   a head connected to the shaft at a longitudinal end of the shaft;
   a damping ring positioned circumferentially around the shaft and below the head, the damping ring including:
      a bearing material positioned circumferentially around and contacting an outer surface of the shaft, and
      a damping material positioned circumferentially around the bearing material and fixed relative to the bearing material, wherein the damping material has a lesser durometer than the bearing material.

In at least one example, a directional input stick according to section 1 allows for the reduction in noise or tactile vibration created by contact between the shaft and a body of a controller. The damping material may absorb at least a portion of the vibrations while the bearing material reduces and/or prevents any resistance to the movement of the directional input stick while contacting a body of a controller.
2. The input stick of section 1, wherein the bearing material is a polyoxymethylene.
3. The input stick of sections 1 or 2, wherein the damping material is an elastomer.
4. The input stick of any preceding section, wherein the damping ring is rotatable around the shaft relative to a center axis of the shaft.

In at least one example, a directional input stick according to section 4 allows the damping ring to rotate around the shaft and function as a bearing between the body of the controller and the shaft when a user makes a sweeping motion with the directional input stick.
5. The input stick of any preceding section, further comprising a mechanical interlock between the bearing material and the outer surface of the shaft.
6. The input stick of section 5, wherein the mechanical interlock includes a circumferential recess around the shaft and a complementary protrusion positioned in the recess.

In at least one example, a directional input stick according to section 6 allows the damping ring to rotate freely around the shaft while remaining fixed in an axial direction on the shaft to reduce and/or prevent noise or vibration from axial movement.
7. The input stick of any preceding section, wherein the head is removable from the shaft, and the damping ring is removable from the shaft to replace the damping ring.

In at least one example, a directional input stick according to section 7, allows a user to replace or repair the damping ring or to customize the feel or performance of a controller by selecting a damping ring with a particular diameter or durometer.
8. The input stick of any preceding section, wherein the bearing material includes race bearings.
9. The input stick of any preceding section, wherein the damping ring is axially movable relative to the shaft.
10. An electronic device controller, the controller comprising:
   a body having a top face with an aperture therein;
   a directional input stick positioned in the aperture and movable relative to the body to receive user inputs, the directional input shaft including:
      a shaft, and
      a head connected to the shaft at a longitudinal end of the shaft; and
   a damping ring positioned circumferentially between an edge of the aperture and the directional input stick, the damping ring including:
      a bearing material, and
      a damping material fixed relative to the bearing material, wherein the damping material has a lesser durometer than the bearing material.
11. The controller of section 10, wherein the directional input stick is tiltable relative to the top face of the body with a range of motion allowing the directional input stick to apply a force to the edge of the aperture.
12. The controller of section 11, wherein the damping ring limits the range of motion of the directional input stick.
13. The controller of any of sections 10-12, wherein the damping ring is connected to the body.
14. The controller of section 13, wherein the bearing material of the damping ring is positioned adjacent the edge of the aperture and rotatable relative to the body.
15. The controller of any of sections 10-14, wherein the damping ring is connected to the directional input stick.
16. The controller of section 15, wherein the bearing material of the damping ring is positioned adjacent an outer surface of the shaft and rotatable relative to the shaft.
17. The controller of section 15, wherein the directional input stick is movable in a direction normal to the top face of the body and the damping ring is axially movable on the shaft.
18. An electronic device controller, the controller comprising:
   a controller body,
   a directional input stick movable relative to the controller body;
   a damping ring positioned circumferentially between an edge of the aperture and the directional input stick and limiting a rotational range of motion of the directional input stick, the damping ring including:
      a bearing material, and
      a damping material fixed relative to the bearing material, wherein the damping material has a lesser durometer than the bearing material;
   a positional sensor configured to measure a position of the directional input stick relative to the controller body;
   a memory storage device, the memory storage device having input device settings stored thereon; and
   a processor in data communication with the positional sensor, the processor configured to determine a directional input magnitude based on a positional measurement from the positional sensor and the input device settings.

In at least one example, a directional input stick according to section 18 allows the damping ring to dampen impacts between the shaft and the body of the controller irrespective of the element to which the damping ring is fixed. The processor can allow the controller to adjust input magnitudes as the user customizes the controller with different damping rings and/or directional input sticks.
19. The electronic device controller of section 18, the input device settings including a input coefficient.
20. The electronic device controller of sections 18 or 19, the input device settings including a limit value.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the implementations that falls within the meaning and scope of the claims is to be embraced by the claims.

It should be understood that any directions or reference frames in the preceding description are merely relative directions or movements. For example, any references to “front” and “back” or “top” and “bottom” or “left” and “right” are merely descriptive of the relative position or movement of the related elements.

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A directional input stick, the input stick comprising:
a shaft;
a head connected to the shaft at a longitudinal end of the shaft;
a damping ring positioned circumferentially around the shaft and below the head, the damping ring including:
a bearing material positioned circumferentially around and contacting an outer surface of the shaft, and
a damping material positioned circumferentially around the bearing material and fixed relative to the bearing material, wherein the damping material has a lesser durometer than the bearing material.

2. The input stick of claim 1, wherein the bearing material is a polyoxymethylene.

3. The input stick of claim 1, wherein the damping material is an elastomer.

4. The input stick of claim 1, wherein the damping ring is rotatable around the shaft relative to a center axis of the shaft.

5. The input stick of claim 1, further comprising a mechanical interlock between the bearing material and the outer surface of the shaft.

6. The input stick of claim 5, wherein the mechanical interlock includes a circumferential recess around the shaft and a complementary protrusion positioned in the recess.

7. The input stick of claim 1, wherein the head is removable from the shaft, and the damping ring is removable from the shaft to replace the damping ring.

8. The input stick of claim 1, wherein the bearing material includes race bearings.

9. The input stick of claim 1, wherein the damping ring is axially movable relative to the shaft.

10. An electronic device controller, the controller comprising:
a body having a top face with an aperture therein;
a directional input stick positioned in the aperture and movable relative to the body to receive user inputs, the directional input shaft including:
a shaft, and
a head connected to the shaft at a longitudinal end of the shaft; and
a damping ring positioned circumferentially between an edge of the aperture and the directional input stick, the damping ring including:
a bearing material, and
a damping material fixed relative to the bearing material, wherein the damping material has a lesser durometer than the bearing material.

11. The controller of claim 10, wherein the directional input stick is tiltable relative to the top face of the body with a range of motion allowing the directional input stick to apply a force to the edge of the aperture.

12. The controller of claim 11, wherein the damping ring limits the range of motion of the directional input stick.

13. The controller of claim 10, wherein the damping ring is connected to the body.

14. The controller of claim 13, wherein the bearing material of the damping ring is positioned adjacent the edge of the aperture and rotatable relative to the body.

15. The controller of claim 10, wherein the damping ring is connected to the directional input stick.

16. The controller of claim 15, wherein the bearing material of the damping ring is positioned adjacent an outer surface of the shaft and rotatable relative to the shaft.

17. The controller of claim 15, wherein the directional input stick is movable in a direction normal to the top face of the body and the damping ring is axially movable on the shaft.

18. An electronic device controller, the controller comprising:
a controller body,
a directional input stick movable relative to the controller body;
a damping ring positioned circumferentially between an edge of the aperture and the directional input stick and limiting a rotational range of motion of the directional input stick, the damping ring including:
a bearing material, and
a damping material fixed relative to the bearing material, wherein the damping material has a lesser durometer than the bearing material;
a positional sensor configured to measure a position of the directional input stick relative to the controller body;
a memory storage device, the memory storage device having input device settings stored thereon; and
a processor in data communication with the positional sensor, the processor configured to determine a directional input magnitude based on a positional measurement from the positional sensor and the input device settings.

19. The electronic device controller of claim 18, the input device settings including a input coefficient.

20. The electronic device controller of claim 18, the input device settings including a limit value.
